(19) United States
(12) Patent Application Publication
(10) Pub. No.: US 2005/0045021 A1
(43) Pub. Date: Mar. 3, 2005

(54) Strap button and attachment

(75) Inventors: Richard I. Berger, Moreland Hills, OH (US); Bruce A. Bishop JR., Pinehurst, NC (US)

Correspondence Address: HAHN LOESER & PARKS, LLP, One GOJO Plaza, Suite 300, AKRON, OH, 44311-1076, US

(73) Assignee: Grover Musical Products, Inc.

(21) Appl. No.: 10/888,739

(22) Filed: Jul. 9, 2004

Related U.S. Application Data
(60) Provisional application No. 60/486,518, filed on Jul. 11, 2003.

(51) Int. Cl. G10D 3/16; G10D 3/00; G10G 5/00

(52) U.S. Cl. 84/327

(57) ABSTRACT

An improved strap button and attachment wherein a carrying strap may be securely attached to musical instrument. The improved strap attachment features a two-piece design that includes a lug having a shaft upon which a hole in the strap slips around and button-type face cap that retains the strap in place. The face cap also features an ornamental design that makes the strap button more appealing. Damage to the musical instrument and transfer of musical vibrations from the instrument to the strap button is limited by the placement of rubber o-rings between the face cap and the lug of the strap button and/or between the bottom surface of the lug and instrument body.

### PRIORITY

This application claims priority to application Ser. No. 60/486,518, filed Jul. 11, 2003, the disclosure of which is hereby incorporated by reference.

### FIELD OF THE INVENTION

The present invention relates to fasteners or a strap button, which secures a strap to a musical instrument such as a guitar. The improved strap fastener of the present invention features a two-piece design that includes a button-type face attachment or cap, which prevents the strap from slipping off of the shaft of the lug. The face cap also features an ornamental design that makes the strap button more appealing. Furthermore, damage to the musical instrument and strap is prevented by placing rubber o-rings between the face cap and the lug of the strap button; and/or between the bottom surface of the lug and the instrument body. While a guitar is used to illustrate the operation of the present invention, it is understood by those in the art that this strap button fastener may be used with other portable musical instruments or objects such as banjo's, keyboards, drums, luggage, purses, etc.

### BACKGROUND

Musicians often secure a strap of leather, fabric, rubber or other material to their musical instruments so that they may be more easily carried and played. Most guitar straps include a hole at opposite ends so that the strap may be attached to the instrument at two places. In particular, Guitar strap buttons, also referred to as lugs or end pins, are secured to a guitar by a variety of fastening means to mate with the holes on the guitar straps.

Many musicians who use guitar straps as described above have a problem with the strap slipping off of the button while the instrument is being played or carried. Musicians are also concerned that strap buttons may make rattling noises as vibrations from the musical instrument are transferred to the strap button. In addition, the act of fastening the strap button to a guitar can scratch or damage the surface finish of the guitar.

Therefore, the present invention to provides an improved musical instrument strap button for preventing the end of a carrying strap from slipping off the attachment button. The present invention also provides a means for attaching a strap button to a musical instrument that limits the transfer of vibrations between the instrument and the strap button. A means is also provided to prevent scratches or other damage to the instrument when the strap button is attached. In addition, the present invention provides a strap button that adds decorative ornamentation to a musical instrument.

Summary of the Invention The present invention is directed to a strap button for attaching a carrying strap to a musical instrument and that satisfies the need for preventing instrument damage and strap slippage. The present invention provides a strap button that is secured to a guitar or other portable musical instrument for holding attaching a carrying strap. In one embodiment, the lug body or endpin has a bore and a fastening means. A screw or other fastening means is secured through the bore for fastening the lug to a musical instrument. The lug body and fastening means may also be constructed as a single unit. In another embodiment, the rear portion of the lug or endpin includes a means for attaching the lug to the guitar. In another embodiment, the rear portion of the lug includes an annular groove therein. A cushioning means is positioned in the groove for minimizing damage or scratching caused by the metal lug body being positioned against the surface of the musical instrument. In still another embodiment, the rear portion of the lug has cushioning material disposed along the bottom surface of the lug to prevent damage to the musical instrument.

The present invention further comprises a detachable head or face cap for the strap button. The face cap is positioned on the top portion of the lug body to prevent the guitar strap from slipping off of the lug. A cushioning means, such as a rubber o-ring is optionally positioned between the lug and the face cap of the strap button to prevent damage to the fasteners. In addition, the face cap or attachment may include a decorative design to add to the aesthetics of the musical instrument.

### BRIEF DESCRIPTION OF THE DRAWINGS

FIG. 1 illustrates a guitar with strap buttons positioned thereon.

FIG. 2 illustrates an end portion of a typical guitar strap.

FIG. 3 is an exploded side view of the guitar strap button in accordance with the present invention.

FIG. 4 is an exploded side view of a lug or endpin body and face attachment in accordance with the present invention.

FIG. 5 is a bottom view of a lug body in accordance with the present invention;

FIG. 6 is a bottom view of a lug body including an o-ring in accordance with the present invention;

FIG. 7 is an exploded side view of a lug or endpin body with fixed attachment device and detachable face attachment in accordance with the present invention.

FIG. 8 is another embodiment of a guitar strap button face attachment in accordance with the present invention.

FIG. 9 is another embodiment of a guitar strap button face attachment in accordance with the present invention.

FIG. 10 is another embodiment of a guitar strap button face attachment in accordance with the present invention.

FIG. 11 is another embodiment of a guitar strap button face attachment in accordance with the present invention.

### DETAILED DESCRIPTION OF THE INVENTION

The present invention will be described herein with reference to the attached figures. It should be understood that although specific embodiments are shown in the drawings and described herein, variations of these embodiments are clearly within the scope of the present invention. Variations on materials, sizes, shapes or any other components of the device or method described herein may be varied and still be encompassed by the scope of the claims herein. While the invention is illustrated for use with a guitar, the invention may also be directed for use with other musical instruments, portable devices, luggage and/or carrying cases and bags.

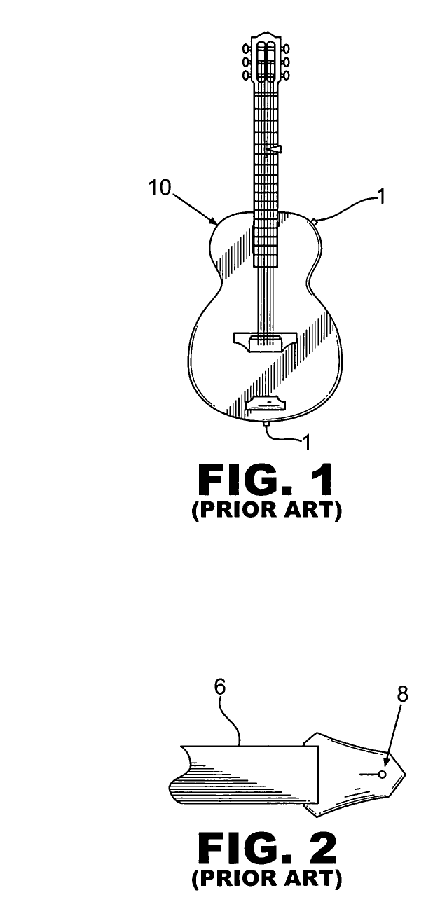

Turning now to FIGS. 1 and 2, there is shown a typical guitar 10 and an end portion of a guitar strap 6 in accordance with the prior art. The guitar includes lugs or endpins 1 positioned thereon for mating with a hole 8 in the end portions of a guitar strap 6. Lugs are attached to guitars by various methods. In some cases, a hole may be drilled or bored into the guitar before fastening the strap button to the guitar. In other cases, the button may be attached to the guitar by use of a screw or nail, fastened directly to the guitar without a previously made bore in the guitar.

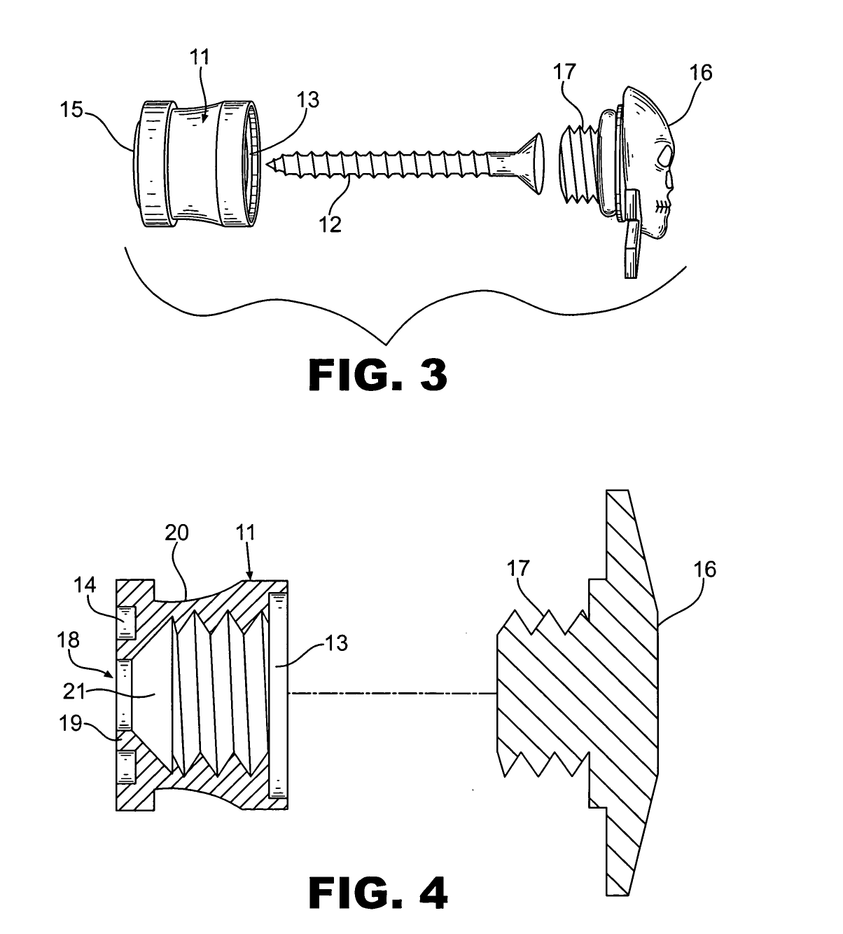

Referring to FIGS. 3 and 4, the lug body 11 has a sleeve-like configuration and includes a rear portion 19 and a front portion 13. The lug is designed such that the strap hole 8 (FIG. 2) slides over the front portion 13 and rests along the shaft portion 20. The shaft portion 20 has an area of lesser diameter than the front 13 or rear 19 portions, which enables the strap to be retained in place. The strap is then locked into place once the face cap 16 is attached to the lug.

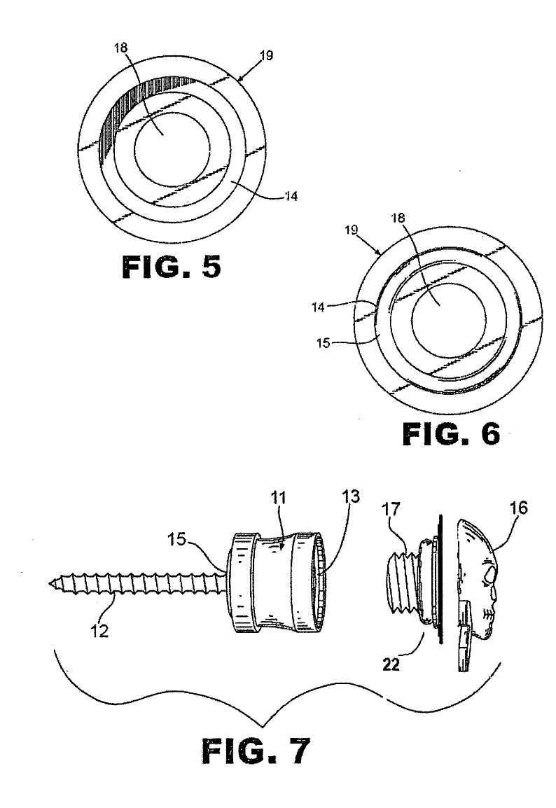

FIGS. 3, 4, 5 and 6 illustrate one embodiment of the lug or endpin of the present invention. The lug body has an internal bore 21 therethrough to facilitate the mounting of the lug on the guitar. As seen in FIGS. 3 and 4, the shaft of screw 12 passes through the bore and opening 18 and into the body of the musical instrument. The counter bore 21 retains the head of screw in place within the lug. In another embodiment, FIG. 7, of the present invention the lug body 11 and fastening means 12 may be formed as a single unit where the fastening means is integral with or permanently attached to the bottom portion of the lug body. The bottom surface 19 of the lug body 11 is positioned adjacent to the guitar when the lug is fastened to the guitar. In one embodiment of the present invention, the bottom portion 19 of the lug body 11 includes an annular groove 14 and an opening 18. The lug may be made of various materials such as metal or plastic, depending on the desired strength of the part. In a preferred embodiment of the invention, the lug 11 is made of metal. The annular groove may be formed in the bottom of the lug body by machining, molding, casting or other known means.

In one embodiment of the present invention, an o-ring 15 is positioned in the groove 14 on the bottom surface 19 of the lug 11. The o-ring 15 serves as a cushion between the lug 11 and the surface of the musical instrument. This cushioning device both prevents damage to the musical instrument and limits the transfer of vibrations between the instrument and the lug, thus preventing unwanted sounds. It should be understood that the o-ring could be made of various materials capable of providing a cushioning effect without departing from the scope of the present invention. For instance, the o-ring may be formed of rubber, plastic, cloth, felt, or foam.

The lug or endpin 11 is secured to the guitar by a fastening means. As shown in FIG. 3, in one embodiment of the present invention, the fastening means comprises a screw 12. Other fastening means are contemplated by this invention including but not limited to bolts, nails, tacks, pins, or adhesives. In use, the fastening means may be positioned through the bore in the lug body. Alternatively, the fastening means may be integrally formed with or attached to the lug body. In the embodiment shown in FIG. 3, the fastening means is a screw 12 that traverses the lug 11 so that the threaded portion bores into the guitar and the head engages the inner surface of the bottom of the lug. In this embodiment, the screw 12 may be tightened down to securely fasten the lug to the guitar. The o-ring 15 cushions the interface between the lug and the surface, preventing the damage to the guitar and limiting the transfer of musical vibrations thru the lug.

FIGS. 3 and 4 also show a face cap or head attachment for a strap button of the present invention. In one embodiment, the top portion of the lug body or endpin 13 is at least partially open. The top portion of the lug body 13 and the face or head attachment 16 include complimentary fastening means for mating the lug 11 to the face cap 16. An o-ring 20 is disposed along the interface between the face and the lug body to limit the transfer of musical vibrations and/or damage to the lug. In one embodiment, the top opening 13 of the lug includes a threaded portion and the back of the face cap 16 includes a complementary threaded portion. Other types of complementary fastening means are contemplated by the present invention. For instance, the top portion of the lug may be formed as a bolt with threads around its outside perimeter. The bottom of the attachment could be a corresponding nut for the bolt to fasten the attachment to the lug. In an alternative, the lug body and attachment may be held together by frictional engagement, snaps, cam action, clips, spring fasteners, detents, or other fastening means.

The lug or endpin may alternatively be formed or positioned on the instrument body by the manufacturer. The lug may be integrally formed in the body of the musical instrument or permanently or removably attached to the guitar during the manufacturing process by a variety of means. In such an embodiment, the top portion of the lug body may be formed so that it is capable of mating with a face or head attachment as described herein. The decorative portion of the face cap may be formed so that it is detachable, FIG. 7, from the body of the face of cap, thus, different ornamental designs could be attached to the face cap body. In addition, the present invention may provide a retro-fit kit for attaching the face or head pieces to existing endpins. Or, the rear portion of the face cap or head portion may be formed so that it is capable of being attached to different types of commercially available musical instrument strap buttons.

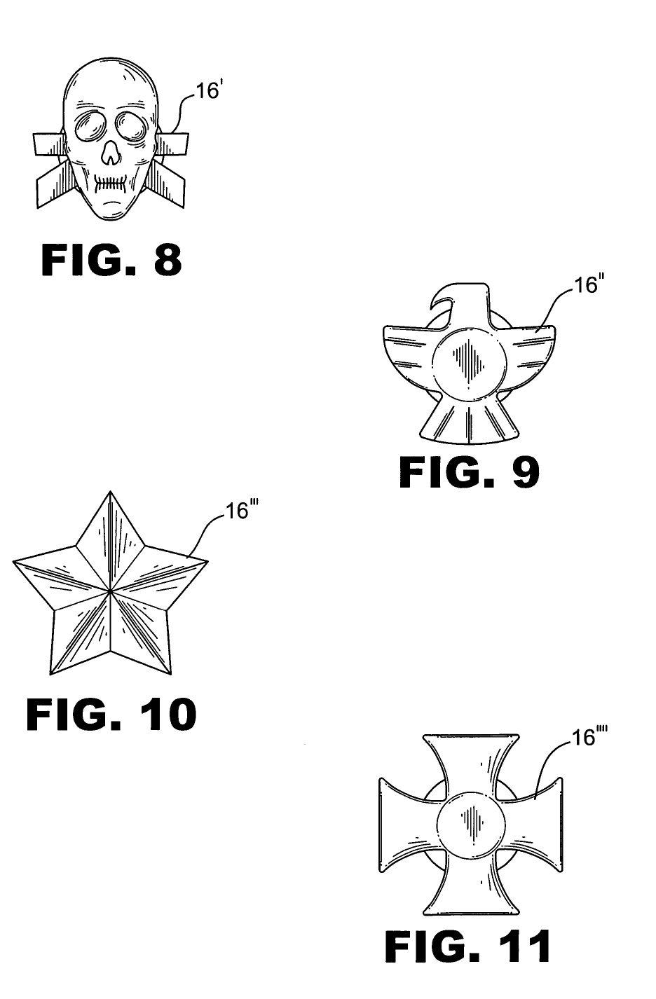

FIGS. 8-11 show various decorative elements, which may be imparted to the face attachment. The attachment may include the design of a skull and cross bones 16′, an eagle 16″, a star 16″′, or a cross 16″″. The designs shown here are only representative examples of decorative elements that may be added to the guitar strap button of the present invention. Other designs are certainly within the scope of the present invention.

It should be understood that the face or head attachment can take on a variety of decorative forms, but need not include any decorative elements at all. For instance, the face or head attachment may be formed in various shapes. Further, the face or head may be integrally formed with or permanently attached to the top portion of the lug body. In such a case, the face cap or head attached to the lug body is measurably wider than the lower portion of the lug body for preventing the strap from slipping off of the strap button.

It should be understood that the present invention is not limited to the embodiments herein shown and described. Variations on these embodiments are contemplated by the present invention and covered by the claims.

1. A method for attaching a strap to a musical instrument comprising:
positioning a lug adjacent to a musical instrument body, said lug having a top edge surface, a bottom edge surface, an outer wall and a central bore therethrough;
attaching said lug to said musical instrument with a fastening means;
placing said carrying strap over said top edge surface of said lug;
attaching a face cap to said top edge surface of said lug.

2. The method defined in claim 1 wherein said top edge surface of said lug is adapted to receive a compatible fastening means on said face cap.

3. The method defined in claim 1, further comprising removably attaching said face cap to said top edge surface of said lug.

4. The method defined in claim 1, wherein a cushioning means is disposed between said lug and said musical instrument and/or between said lug and said face cap.

5. The method defined in claim 4, wherein said cushioning means limits transfer of vibrations between said musical instrument and said lug.

6. The method defined in claim 2, wherein said compatible fastening means comprises a screw, snaps, cam action, clips, spring fasteners, or detent attachment.

7. The method defined in claims 4, where said cushioning means is comprised of rubber, plastic, cloth, felt or foam.

8. The method defined in claim 1, further comprising a face cap that is ornamental.

9. A device for attaching a carrying strap to a musical instrument comprising:
a lug having a top edge surface, a bottom edge surface, an outer wall and a central bore through said lug, said bottom surface positioned adjacent said musical instrument;
means for attaching said lug to said musical instrument;
a face cap;
wherein said top edge surface of said lug is adapted to receive a compatible fastening means of said face cap.

10. The device defined in claim 9, wherein said face cap is removably attached to said top portion of said lug.

11. The device defined in claim 9, wherein said compatible fastening means of said face cap consists of one or more of the following: screw, snap, cam action, clips, spring fasteners, or detent attachment.

12. The device defined in claim 9, wherein a bottom portion of said lug has a cushioning device disposed between said lug and said musical instrument and/or between said compatible fastening means of said face cap and said top edge surface of said lug.

13. The device defined in claim 12, wherein said cushioning device comprises rubber, plastic, cloth, felt or foam.

14. The device defined in claim 9, wherein a portion of said face cap is ornamental.

15. A guitar strap button comprising:
a lug having a bore there through;
said lug having a top opening and a bottom surface, said bottom surface positioned adjacent a guitar;
a screw for fastening said lug to a guitar;
wherein said bottom surface of said lug has a groove therein;
a o-ring positioned in said groove; and
a decorative face cap, wherein a rear portion of said face cap comprises complimentary attachment means to said top opening of said lug.

16. The guitar strap button defined in claim 15, wherein said face cap is removably attached to said top portion of said lug.

17. The guitar strap button defined in claim 15, wherein a bottom surface of said lug has a cushioning means disposed between said lug and said musical instrument and/or between said lug and said face cap.

18. The guitar strap button defined in claim 15, wherein said face cap includes a screw, snaps, cam action, clips, spring fasteners, or detent attachments.

19. The guitar strap button defined in claim 17, wherein said cushioning means comprises rubber, plastic, cloth, felt or foam.

20. The face cap defined in claim 15, wherein said decorative portion of said face cap is detachable from the body of said face cap.
